(19) United States
(12) Patent Application Publication
(10) Pub. No.: US 2023/0420648 A1
(43) Pub. Date: Dec. 28, 2023

(54) POSITIVE ELECTRODE PLATE FOR LITHIUM-ION RECHARGEABLE BATTERY, AND LITHIUM-ION RECHARGEABLE BATTERY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventor: Kazuya TAGA, Hamamatsu-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/212,072

(22) Filed: Jun. 20, 2023

(30) Foreign Application Priority Data
Jun. 24, 2022 (JP) 2022-101947

(51) Int. Cl. H01M 4/36; H01M 4/525; H01M 4/583; H01M 10/0525

(52) U.S. Cl. CPC H01M 4/364; H01M 4/525; H01M 2004/028; H01M 10/0525; H01M 4/583

(57) ABSTRACT

A positive electrode plate for a lithium-ion rechargeable battery includes a positive electrode mixture layer. In the positive electrode mixture layer, a fibrous conductor is combined with a positive electrode active material in which an amount of lithium carbonate with respect to the positive electrode active material is between 0.31 wt % and 1.29 wt %, inclusive. A composition ratio of the fibrous conductor to the positive electrode active material is between 0.5 wt % and 2.0 wt %, inclusive. A coverage of the fibrous conductor to the positive electrode active material is 11.0% or less.

### BACKGROUND

### 1. Field

The following description relates to a positive electrode plate for a lithium-ion rechargeable battery and a lithium-ion rechargeable battery that have improved battery life characteristics.

### 2. Description of Related Art

Lithium-ion rechargeable batteries have large capacities and generate high voltage. Thus, lithium-ion rechargeable batteries are used in, for example, vehicles such as battery electric vehicles and hybrid electric vehicles. Lithium-ion rechargeable batteries are also used in houses and factories as stationary batteries. There is a need for such lithium-ion rechargeable batteries to have even higher outputs.

Accordingly, there are inventions disclosing that even with a small amount of a fibrous conductor, such as carbon nanotubes (CNT), carbon nanofibers (CNF), or the like, a conductive network can be formed between particles of a positive electrode active material to increase the ratio of the positive electrode active material in a positive electrode mixture layer.

For example, Japanese Laid-Open Patent Publication No. 2009-272041 discloses a lithium-ion rechargeable battery in which microscopic carbon fibers are attached in a meshed manner to the particle surfaces of a positive electrode active material and a negative electrode active material, where all or some of the carbon fibers are modified with a hydrophilic group. Further, in Japanese Laid-Open Patent Publication No. 2015-519699, a surface active agent formed from a fibrous carbon material, such as carbon nanotubes, is adhered to the surface of a conductive material to restrict secondary aggregation of the conductive material and capture a binder. In this manner, the conductive material limits aggregation of a positive electrode material and a negative electrode material. As disclosed in Japanese Laid-Open Patent Publication Nos. 2009-272041 and 2015-519699, the positive electrode mixture layer includes a fibrous conductor such as carbon nanotubes. With such a structure, the fibrous conductor forms conductive paths. This ensures excellent battery performance.

### SUMMARY

As described above, the carbon nanotubes or the like increase the battery capacity. Further, the conductive paths formed by the carbon nanotubes increase the reactive area and decrease the reaction resistance, thereby improving input/output of the battery.

However, the present inventors have found that since the surface of the positive electrode active material contacting with a nonaqueous electrolyte increases, when the nonaqueous electrolyte decomposes in a high-temperature environment during energization, storage, or the like, NiO₂, which is the positive electrode active material, may undergo reductive decomposition and generate NiO. In this case, NiO will accelerate deterioration of the battery and shorten the battery life.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a positive electrode plate for a lithium-ion rechargeable battery includes a positive electrode mixture layer. In the positive electrode mixture layer, a fibrous conductor is combined with a positive electrode active material in which an amount of lithium carbonate with respect to the positive electrode active material is between 0.31 wt % and 1.29 wt %, inclusive. A composition ratio of the fibrous conductor to the positive electrode active material is between 0.5 wt % and 2.0 wt %, inclusive. A coverage of the fibrous conductor to the positive electrode active material is 11.0% or less.

In the positive electrode plate for a lithium-ion rechargeable battery, the positive electrode active material may be represented by a chemical formula of LiNiₓCo_{y}M_{z}O₂. When “M” represents one or more types of metals selected from a group consisting of Fe, Cu, Ti, Mg, Al, W, B, Mo, Nb, Zn, Sn, Zr, Ga, and V, a composition ratio of Li/M may be between 1.15 and 1.21, inclusive.

In the positive electrode plate for a lithium-ion rechargeable battery, when “M” represents one or more types of metals selected from a group consisting of Fe, Cu, Ti, Mg, Al, W, B, Mo, Nb, Zn, Sn, Zr, Ga, and V, the positive electrode active material may be represented by a chemical formula of LiNiₓCo_{y}M_{z}O₂, x=1-y-z may be satisfied, 0<x≤0.5 may be satisfied, 0.2≤y≤0.5 may be satisfied, y+z≥0.5 may be satisfied, and y/x≥0.98 may be satisfied.

In this case, the “x” may satisfy x≤0.37.

In the positive electrode plate for a lithium-ion rechargeable battery, the fibrous conductor may be formed by carbon nanotubes or carbon nanofibers. In this case, the fibrous conductor may have a length of 100 nm to 1000 nm.

In another general aspect, a lithium-ion rechargeable battery includes the above positive electrode plate for a lithium-ion rechargeable battery.

Other features and aspects will be apparent from the following detailed description, the drawings, and the claims.

### BRIEF DESCRIPTION OF THE DRAWINGS

FIG. 1 is a perspective view schematically showing the structure of a lithium-ion rechargeable battery in accordance with the present embodiment.

FIG. 2 is a diagram schematically showing the structure of a roll of an electrode body in accordance with the present embodiment.

FIG. 3 is a diagram schematically showing a positive electrode including a small amount of lithium carbonate.

FIG. 4 is a diagram schematically illustrating deterioration of the positive electrode including the small amount of lithium carbonate.

FIG. 5 is a diagram schematically showing a positive electrode including a sufficient amount of lithium carbonate.

FIG. 6 is a diagram schematically illustrating that deterioration is limited in the positive electrode including the sufficient amount of lithium carbonate.

FIG. 7 is a table of experimental examples showing the relationship of a total carbon amount TC (wt %) and a durability characteristic (%).

FIG. 8 is a graph showing the relationship of the total carbon amount TC (wt %) and the durability characteristic (%).

FIG. 9 is a table of experimental examples showing the relationship of a CNT coverage (%) and an output characteristic (%).

FIG. 10 is a graph showing the relationship of the CNT coverage (%) and the output characteristic (%).

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

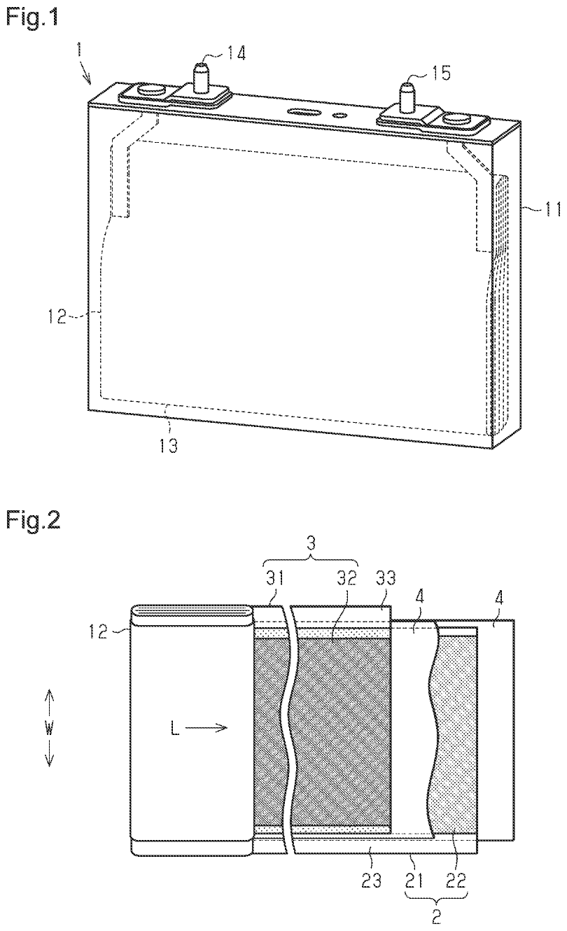

A positive electrode plate for a lithium-ion rechargeable battery and a lithium-ion rechargeable battery in accordance with an embodiment of the present disclosure will now be described with reference to FIGS. 1 to 10.

Outline of Present Embodiment

Fibrous Conductor 32b

As described in Description of Related Art section, a fibrous conductor 32b including carbon nanotubes or the like increases the battery capacity. Further, the conductive paths formed by the carbon nanotubes increase the reactive area and decrease the reaction resistance, thereby improving the input/output of the battery.

Generation of NiO

However, in a high-temperature environment during energization, storage, or the like, NiO may be generated when electrolyte decomposition occurs. The generated NiO will accelerate deterioration of the battery.

The present inventors have analyzed the cause. As shown in FIG. 4, when the surface of a positive electrode active material 32a contacting a nonaqueous electrolyte 13 increases, the positive electrode active material 32a will tend to undergo reductive decomposition during decomposition of the nonaqueous electrolyte, which is caused by a temperature rise during energization, storage, or the like. In this case, a reaction of NiO₂-NiO+0.5O₂ generates NiO, which does not contribute to the main reaction.

When NiO is generated, the generated NiO forms a structure within the layered rock-salt structure of the positive electrode active material 32a. The present inventors have found that this limits intercalation of lithium ions (L⁺) used in the main reaction and decreases the amount of electrons used in the main reaction.

Then, the present inventors have focused on lithium carbonate 32c (Li₂CO₃) that is typically recognized in the art as an impurity resulting from generation of the positive electrode active material that should be eliminated. As shown in FIG. 6, it was found that the existence of a certain amount of lithium carbonate 32c will result in a reaction of ROCO₂R′+Li₂CO₃→ROLi+R′OLi+2CO₂ (“R” and “R′” are substituent group) during the decomposition of the electrolyte, thereby restricting generation of NiO.

Lithium Carbonate

Typically, lithium carbonate is an impurity in the positive electrode active material and is a substance that decreases the battery capacity. Thus, lithium carbonate is a component that should be eliminated at a high temperature when the positive electrode active material undergoes a firing step.

Nonetheless, there are inventions that disclose a nonaqueous rechargeable battery in which lithium carbonate is included in the positive electrode active material.

For example, Japanese Laid-Open Patent Publication No. 2002-313340 discloses a structure in which lithium carbonate is included in a positive electrode active material. If the battery is overcharged, the lithium carbonate included in the positive electrode active material will be electrochemically decomposed and generate carbon dioxide gas. This actuates a current cut-off mechanism that interrupts the charging current and avoids a rapid temperature rise of the battery to ensure safety of the battery. In the invention of Japanese Laid-Open Patent Publication No. 2002-313340, although lithium carbonate is recognized as a substance that generates carbon dioxide gas, it is not recognized that lithium carbonate restricts generation of NiO.

Further, Japanese Laid-Open Patent Publication No. 2018-172255 discloses a positive electrode active material having a Li/Me ratio of 1.00 to 1.20, and a residue of sulfate radical+lithium carbonate of 0.3 wt % or less used to increase the output of the battery. In such a positive electrode active material, Li₂CO₃≤0.3 wt % is satisfied when all of the residue is Li carbonate.

The positive electrode active material is represented by the chemical formula of LiNi_{(1-y-z-w)}Co_{y}Mn_{z}M_{w}O₂. Further, the conditions of such a positive electrode active material include 0<y≤0.5, 0<z≤0.8, 0≤w≤0.1, and y+z+w<1.0.

However, in the invention of Japanese Laid-Open Patent Publication No. 2018-172255, when an increase in the ratio of the positive electrode active material increases the active surface that contacts an electrolyte, the active material will tend to undergo reductive reaction during storage, energization, or the like and accelerate deterioration of the battery. This will limit the amount of lithium carbonate in the invention of Japanese Laid-Open Patent Publication No. 2018-172255, and, thus, the amount of lithium carbonate is extremely small compared to the content of lithium carbonate in the present embodiment. Accordingly, the invention of Japanese Laid-Open Patent Publication No. 2018-172255 does not recognize that lithium carbonate restricts generation of NiO.

First Condition of Present Embodiment

The positive electrode active material 32a in a positive electrode mixture layer 32 of a positive electrode plate 3 of a lithium-ion rechargeable battery 1 in accordance with the present embodiment includes lithium carbonate 32c. The amount of lithium carbonate 32c with respect to the positive electrode active material 32a is set between 0.31 wt % and 1.29 wt %, inclusive.

When a certain amount of lithium carbonate 32c is included, the lithium carbonate 32c, instead of the positive electrode active material 32a, undergoes a reaction such as ROCO₂R′+Li₂CO₃→ROLi+R′OLi+2CO₂ during the decomposition of the electrolyte.

Examples of the nonaqueous electrolyte 13 of the present embodiment include ethylene carbonate (EC), dimethyl carbonate (DMC), ethyl methyl carbonate (EMC), and the like. Examples of the side chains —R and —R′ include —CH₃, —C₂H₅, —C₃H₆O, —C₂H₃, —SO₂CH₃, and the like.

When the amount of lithium carbonate 32c in carbon equivalent (hereafter, “total carbon amount TC”) is set between 0.05 wt % and 0.21 wt %, inclusive, the amount of lithium carbonate 32c with respect to the positive electrode active material 32a is between 0.31 wt % and 1.29 wt %, inclusive.

The necessary amount of lithium carbonate may be converted from the total carbon amount TC using the following equation.

$$lithium carbonate amount = total carbon amount TC \times ( molecular weight of lithium carbonate / atomic weight of carbon ) = total carbon amount TC \times ( 73.893 / 12.011 ) \approx total carbon amount TC \times 6.152$$

Conductive Material

As described above, even a small mass of the fibrous conductor 32b, such as carbon nanotubes (CNT), carbon nanofibers (CNF), or the like, can form an efficient conductive network. Thus, the fibrous conductor 32b increases the battery capacity. Further, the formed conductive paths increase the reactive area and decrease the reaction resistance, thereby improving the input/output of the battery.

Accordingly, in the present embodiment, the length of the fibrous conductor 32b is set between 100 nm and 1000 nm, inclusive.

No matter how much the conductivity is increased, the main reaction of the positive electrode plate 3 of the lithium-ion rechargeable battery 1 takes place primarily on the surface of the positive electrode active material 32a. Thus, an excessive amount of the fibrous conductor 32b would excessively cover the surface of the positive electrode active material 32a and limit the main reaction of the positive electrode active material 32a.

The ratio of the area where the carbon nanotubes (CNT) of the fibrous conductor 32b cover the surface of the positive electrode active material 32a is defined as the CNT coverage θ (%) (or “coverage θ (%)”). In the present embodiment, the coverage θ (%) is obtained theoretically.

Second Condition of Present Embodiment

In the present embodiment, the amount of the fibrous conductor 32b is set such that the composition ratio of the fibrous conductor 32b with respect to the positive electrode active material 32a is between 0.5 wt % and 2.0 wt %, inclusive. This obtains a necessary and sufficient amount of the fibrous conductor 32b.

Third Condition of Present Embodiment

The coverage θ (%) of the fibrous conductor 32b with respect to the positive electrode active material 32a is specifically set to 11.0% or less. When the coverage θ (%) is greater than 11.0%, the excess amount of the fibrous conductor 32b will excessively cover the surface of the positive electrode active material 32a and limit the main reaction of the positive electrode active material 32a.

Condition 1 for Positive Electrode Active Material 32a

An example of the positive electrode active material 32a in accordance with the present embodiment is represented by the chemical formula of LiNiₓCo_{y}M_{z}O₂. The “M” represents one or more types of metal selected from the group consisting of Fe, Cu, Ti, Mg, Al, W, B, Mo, Nb, Zn, Sn, Zr, Ga, and V. The composition ratio of Li/M is set between 1.15 and 1.21, inclusive.

The composition ratio of Li/M is set to 1.15 or greater so that a sufficient amount of lithium ions are obtained. The composition ratio of Li/M is set to 1.21 or less so that the stability of the battery is enhanced.

Condition 2 for Positive Electrode Active Material 32a

In the present embodiment, in the chemical formula of LiNiₓCo_{y}M_{z}O₂,
(a) x=1-y-z is satisfied, that is, the total of Ni, Co, and M equals to 100 mol %.
(b) 0<x≤0.5 is satisfied, that is, Ni is 50 mol % or less.
(c) 0.2≤y≤0.5 is satisfied, that is, Co is 20 to 50 mol %.
(d) y+z≥0.5 is satisfied, that is, the total of Co and M is 50 mol % or greater, as apparent from (a) and (b).
(e) y/x≥0.98 is satisfied, that is, Co is more than 98 mol % of Ni.

In particular, preferably, the “x” satisfies x≤0.37 . . . (b′).

This is because when Ni has a high composition ratio, cation mixing causes Ni to be positioned where Li should be arranged in the positive electrode active material 32a and decreases the amount of Li. Thus, battery deterioration will be caused by the Ni.

Further, when a large amount of NiO is generated, the generated NiO forms a structure within the layered rock-salt structure of the positive electrode active material 32a. This limits intercalation of lithium ions (L⁺) used in the main reaction and decreases the amount of electrons used in the main reaction. Thus, deterioration will be caused by the Ni.

When “x” (Ni) has a low ratio and “y” (Co) has a high ratio, the total carbon amount TC normally becomes 0.04 or less. This is because Ni slowly reacts with Li and Co quickly reacts with Li. Thus, Li is easily drawn into the crystals of the positive electrode active material 32a. Accordingly, the content of Co is set to 20 to 50 mol %.

Structure of Present Embodiment

The structure of the above lithium-ion rechargeable battery 1 is described below.

Structure of Lithium-Ion Rechargeable Battery 1

FIG. 1 is a perspective view schematically showing the structure of the lithium-ion rechargeable battery 1 in accordance with the present embodiment. The structure of the lithium-ion rechargeable battery 1 of the present embodiment will now be described.

As shown in FIG. 1, the lithium-ion rechargeable battery 1 is structured as a battery cell. The lithium-ion rechargeable battery 1 includes a box-shaped battery case 11 having an opening in the upper side. The battery case 11 accommodates an electrode body 12. The battery case 11 is filled with the nonaqueous electrolyte 13 injected through a liquid injection hole. The battery case 11 is formed from metal, such as an aluminum alloy, and forms a sealed battery container. Further, the lithium-ion rechargeable battery 1 includes a positive electrode external terminal 14 and a negative electrode external terminal 15 used for charging and discharging the lithium-ion rechargeable battery 1. The shapes of the positive electrode external terminal 14 and the negative electrode external terminal 15 are not limited to that shown in FIG. 1.

Electrode Body 12

FIG. 2 is a diagram schematically showing the structure of a roll of the electrode body 12. The electrode body 12 is formed by a flat roll of a negative electrode plate 2 and the positive electrode plate 3 with a separator 4 held in between. In the negative electrode plate 2, a negative electrode mixture layer 22 is formed on a negative electrode current collector 21 that serves as a substrate. The negative electrode plate 2 includes a negative electrode connection portion 23 where the negative electrode mixture layer 22 is not formed and the negative electrode current collector 21 is exposed at one end of the electrode body 12 in a width direction W (rolling axis direction) that is orthogonal to a direction in which the negative electrode current collector 21 is rolled (rolling direction L).

Stack Structure of Electrode Body 12

As shown in FIG. 2, the basic structure of the electrode body 12 of the lithium-ion rechargeable battery 1 includes the negative electrode plate 2, the positive electrode plate 3, and the separator 4.

The negative electrode plate 2 includes the negative electrode mixture layer 22 on both surfaces of the negative electrode current collector 21, which serves as the negative electrode substrate. An end portion of the negative electrode current collector 21 located at one side of the electrode body 12 defines the negative electrode connection portion 23 where metal is exposed.

The positive electrode plate 3 includes the positive electrode mixture layer 32 on both surfaces of the positive electrode current collector 31, which serves as the positive electrode substrate. An end portion of the positive electrode current collector 31 located at the other side of the electrode body 12 defines the positive electrode connection portion 33 where the metal is exposed.

The negative electrode plate 2 and the positive electrode plate 3 are stacked with the separator 4 held in between. The stack is rolled in its longitudinal direction about the rolling axis to form the flat roll of the electrode body 12.

Nonaqueous Electrolyte 13

As shown in FIG. 1, the battery container formed by the battery case 11 is filled with the nonaqueous electrolyte 13. The nonaqueous electrolyte 13 of the lithium-ion rechargeable battery 1 is a composition in which a lithium salt is dissolved in an organic solvent. The lithium salt may include LiClO₄, LiPF₆, LiAsF₆, LiBF₄, LiSO₃CF₃, or the like. Examples of the organic solvent include a cyclic carbonate such as ethylene carbonate (EC), propylene carbonate (PC), butylene carbonate, and trifluoropropylene carbonate (F·PC); a chain carbonate such as diethyl carbonate (DEC), dimethyl carbonate (DMC), ethyl methyl carbonate (EMC), and dipropyl carbonate (DPC); an ether compound such as tetrahydrofuran (TFH), 2-methyltetrahydrofuran (2-MeTHF), and dimethoxyethane; a sulfur compound such as ethyl methyl sulfone and butane sultone; and a phosphorus compound such as triethyl phosphate and trioctyl phosphate. The nonaqueous electrolyte may include one selected from the above or a mixture of two or more selected from the above. The nonaqueous electrolyte 13 is not limited to such a composition.

Components of Electrode Body 12

The components of the electrode body 12, namely, the negative electrode plate 2, the positive electrode plate 3, and the separator 4, will now be described.

In the present embodiment, “average diameter” means a median diameter (D₅₀: 50% volume average particle diameter) that corresponds to 50% accumulation in a volume-based particle size distribution, unless specified otherwise. In the range where the average particle diameter is approximately 1 μm or greater, the average diameter can be obtained by a laser diffraction and light scattering method. In the range where the average particle diameter is approximately 1 μm or less, the average particle diameter can be obtained by a dynamic light scattering (DLS) method. The average particle diameter obtained by the DLS method may be measured in accordance with JISZ8828:2013.

Negative Electrode Plate 2

The negative electrode plate 2 has a structure in which the negative electrode mixture layer 22 is formed on both surfaces of the negative electrode current collector 21, which serves as the negative electrode substrate. The negative electrode current collector 21 is formed by a Cu foil in the embodiment. The negative electrode current collector 21 acts as the body and the base of the negative electrode mixture layer 22. Further, the negative electrode current collector 21 functions as a current collecting member that collects electricity from the negative electrode mixture layer 22. In the present embodiment, a negative electrode active material includes a material that is capable of storing and releasing lithium ions, namely, powders of a carbon material such as graphite or the like.

The negative electrode plate 2 is prepared by, for example, kneading the negative electrode active material, a solvent, and a binder, applying the kneaded negative electrode mixture paste to the negative electrode current collector 21, and then drying the paste.

Positive Electrode Plate 3

The positive electrode plate 3 includes the positive electrode current collector 31 and the positive electrode mixture layer 32 applied to the positive electrode current collector 31.

Positive Electrode Current Collector 31

The positive electrode plate 3 has a structure in which the positive electrode mixture layer 32 is formed on both surfaces of the positive electrode current collector 31, which serves as the positive electrode substrate. The positive electrode current collector 31 is formed by an Al foil in the embodiment. The positive electrode current collector 31 acts as the body and the base and a frame of the positive electrode mixture layer 32. Further, the positive electrode current collector 31 functions as a current collecting member that collects electricity from the positive electrode mixture layer 32.

An Al foil is described above as an example of the positive electrode substrate that forms the positive electrode current collector 31. The positive electrode substrate is formed from, for example, a conductive material including a metal having satisfactory electric conduction. The conductive material may include, for example, a material including aluminum or an aluminum alloy. The structure of the positive electrode current collector 31 is not limited to the above description.

Positive Electrode Mixture Layer 32

The positive electrode mixture layer 32 is formed by applying a positive electrode mixture paste to the positive electrode current collector 31 and drying the paste. The positive electrode mixture layer 32 includes the positive electrode active material 32a including lithium carbonate 32c, the fibrous conductor 32b, a binder 32d, and additives such as a dispersant and the like.

Composition of Positive Electrode Active Material 32a

The primary particles of the positive electrode active material 32a are not limited to those described above and include a lithium transition metal oxide having a layered crystalline structure. The lithium transition metal oxide includes one or more predetermined transition metal elements in addition to Li. Preferably, the transition metal element included in the lithium transition metal oxide is at least one of Ni, Co, and Mn. A preferred example of the lithium transition metal oxide includes every one of Ni, Co, and Mn.

The positive electrode active material 32a may include one or more types of elements in addition to the transition metal element (i.e., at least one of Ni, Co, and Mn). The additional element may include any element in group 1 (alkali metal such as sodium), group 2 (alkaline earth metal such as magnesium or calcium), group 4 (transition metal such as titanium or zirconium), group 6 (transition metal such as chromium or tungsten), group 8 (transition metal such as iron), group 13 (metalloid element such as boron or metal such as aluminum) or group 17 (halogen such as fluorine) of the periodic table.

Fibrous Conductor 32b

The fibrous conductor 32b is a material that forms a conductive path in the positive electrode mixture layer 32. When an appropriate amount of the conductor is mixed in the positive electrode mixture layer 32, the conductivity of the positive electrode is increased. This enhances the charging/discharging efficiency and the output characteristic of the battery. The conductor of the present embodiment may include, for example, the fibrous conductor 32b formed by a carbon material such as carbon nanotubes (CNT), carbon nanofibers (CNF), or the like. Further, it is preferred that the fibrous conductor 32b have the form of a string having an aspect ratio of the length to the diameter of thirty or greater. Preferably, the length of the fibrous conductor 32b is between 100 nm and 1000 nm, inclusive. A length less than 100 nm will hinder the formation of a sufficient conductive network. A length greater than 1000 nm will hinder dispersion of the fibrous conductor 32b.

Binder 32d

The binder 32d may include, for example, polyvinylidene fluoride (PVDF), polytetrafluoroethylene (PTFE), polyacrylic acid, polyacrylate, or the like.

Operation of Present Embodiment

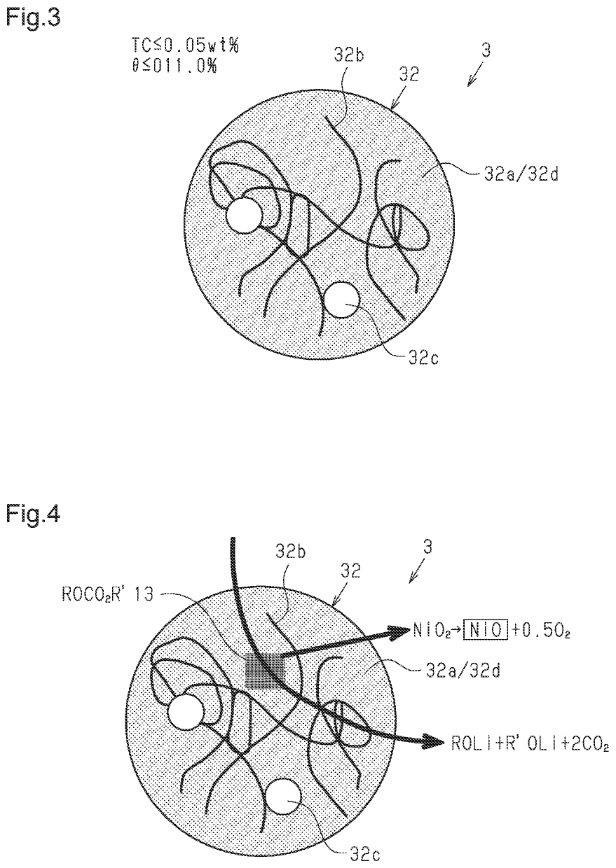

The operation of the lithium-ion rechargeable battery 1 in accordance with the present embodiment will now be described with reference to FIGS. 3 to 6.

FIG. 3 is a diagram schematically showing a positive electrode including a small amount of lithium carbonate 32c. Specifically, the total carbon amount TC, which is an index for the lithium carbonate 32c, is set to 0.05 wt %, and the coverage θ (%) of the fibrous conductor 32b with respect to the positive electrode active material 32a is set to 11.0% or less.

FIG. 4 is a diagram schematically illustrating deterioration of the positive electrode including the small amount of lithium carbonate 32c. When the temperature of the nonaqueous electrolyte 13 of the lithium-ion rechargeable battery 1 becomes high enough due to charging/discharging, micro-short-circuit, or the ambient temperature, electrolysis causes ROCO₂R′ to normally decompose to become ROLi+R′OLi+2CO₂. However, at such a high temperature, a reaction of NiO₂→NiO+0.5O₂ occurs and NiO is generated. The generated NiO causes deterioration as described above. Specifically, the amount of Li in the positive electrode active material 32a is decreased, and the battery capacity is lowered. Furthermore, the generated NiO increases the internal resistance (CD-R).

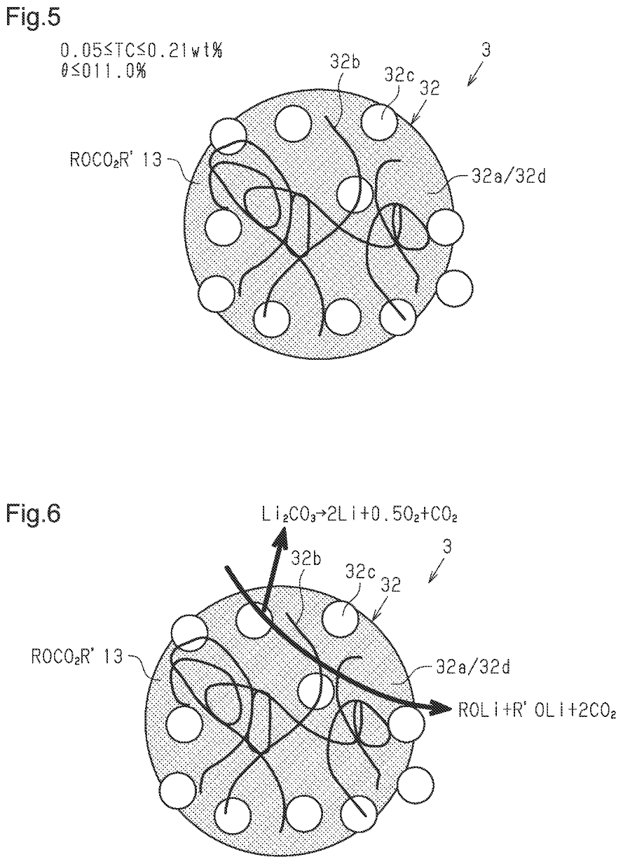

FIG. 5 is a diagram schematically showing a positive electrode including a sufficient amount of lithium carbonate 32c. In contrast to FIG. 3, lithium carbonate 32c is schematically shown by the many white circles in FIG. 5. The total carbon amount TC, which is an index for lithium carbonate 32c, is actually set to as large as 0.05 wt %≤TC≤0.21 wt %. Further, the coverage θ (%) of the fibrous conductor 32b with respect to the positive electrode active material 32a is set to 11.0% or less in the same manner as FIG. 3.

FIG. 6 is a diagram schematically illustrating that deterioration is limited in the positive electrode including the sufficient amount of lithium carbonate 32c. When the temperature of the nonaqueous electrolyte 13 of the lithium-ion rechargeable battery 1 becomes high enough due to charging/discharging, micro-short-circuit, or the ambient temperature, electrolysis cause ROCO₂R′ to decompose in the same manner as in FIG. 4. In this case, during the decomposition of the electrolyte, a reaction of Li₂CO₃→2Li+0.5O₂+CO₂ occurs with respect to lithium carbonate 32c (Li₂CO₃) and restricts the reaction of NiO₂→NiO+0.5O₂. In other words, Li₂CO₃ contributes to the reductive decomposition reaction instead of NiO₂, which is an active material. In this manner, when the total carbon amount TC, which is an index for lithium carbonate 32c, is set to a predetermined amount, the fibrous conductor 32b formed by CNT increases the capacity and the input/output of the battery while generation of NiO from NiO₂ is being restricted. NiO₂ is the positive electrode active material 32a during oxidative decomposition of the nonaqueous electrolyte 13.

Experimental Examples of Present Embodiment

Experiment 1: TC (wt %) and Durability Characteristic (%)

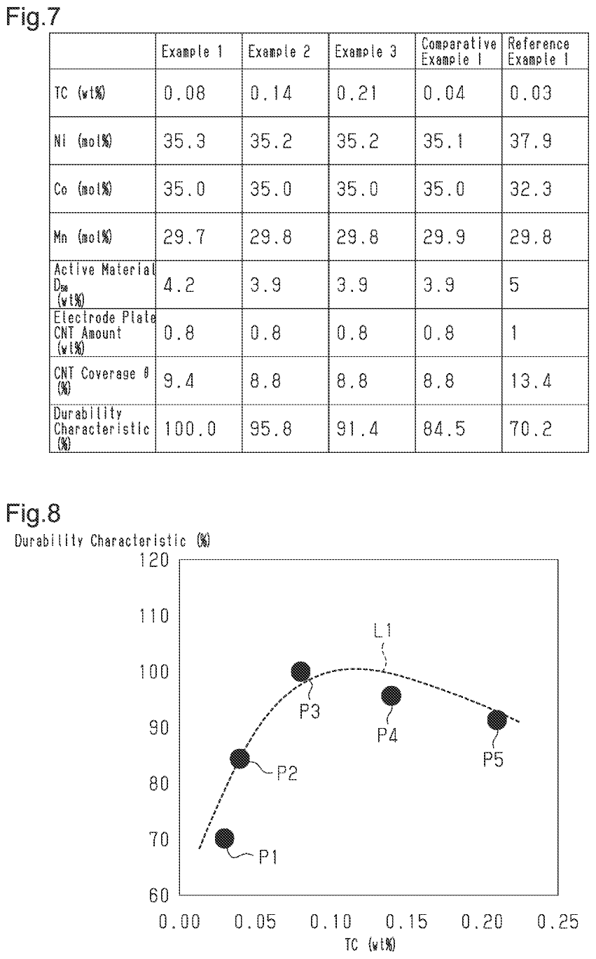

FIG. 7 is a table of experimental examples showing the relationship of the total carbon amount TC (wt %) and the durability characteristic (%). Carbon (C) in the “total carbon amount TC” mainly derives from lithium carbonate 32c (Li₂CO₃). Thus, in the present embodiment, the amount of lithium carbonate 32c is controlled using the amount in carbon equivalent as an index. In the first condition, the total carbon amount TC is set between 0.05 wt % and 0.21 wt %, inclusive, so that the amount of lithium carbonate 32c with respect to the positive electrode active material 32a is between 0.31 wt % and 1.29 wt %, inclusive.

Example 1: The total carbon amount TC was 0.08 wt %, which satisfies the first condition. Ni was set to 35.3 mol %, Co was set to 35.0 mol %, Mn was set to 29.7 mol %, and the active material D₅₀ was set to 4.2 wt %. The electrode plate CNT amount was 0.8 wt %, which satisfies the second condition. The CNT coverage θ was 9.4%, which satisfies the third condition. The durability characteristic in this case was specified as 100%. The “durability characteristic” depends on the charge/discharge amount (Wh) when the battery capacity is equal to the set threshold value.

Example 2: The total carbon amount TC was 0.14 wt %, which satisfies the first condition. Ni was set to 35.2 mol %, Co was set to 35.0 mol %, Mn was set to 29.8 mol %, and the active material D₅₀ was set to 3.9 wt %. The electrode plate CNT amount was 0.8 wt %, which satisfies the second condition. The CNT coverage θ was 8.8%, which satisfies the third condition. The durability characteristic in this case was 95.8%.

Example 3: The total carbon amount TC was 0.21 wt %, which satisfies the first condition. Ni was set to 35.2 mol %, Co was set to 35.0 mol %, Mn was set to 29.8 mol %, and the active material D₅₀ was set to 3.9 wt %. The electrode plate CNT amount was 0.8 wt %, which satisfies the second condition. The CNT coverage θ was 8.8%, which satisfies the third condition. The durability characteristic in this case was 91.4%.

Comparative Example 1: The total carbon amount TC was 0.04 wt %, which does not satisfy the first condition. Ni was set to 35.1 mol %, Co was set to 35.0 mol %, Mn was set to 29.9 mol %, and the active material D₅₀ was set to 3.9 wt %. The electrode plate CNT amount was 0.8 wt %, which satisfies the second condition. The CNT coverage θ was 8.8%, which satisfies the third condition. The durability characteristic in this case was 84.5%.

Reference Example 1: The total carbon amount TC was 0.03 wt %, which does not satisfy the first condition. Ni was set to 37.9 mol %, Co was set to 32.3 mol %, Mn was set to 29.8 mol %, and the active material D₅₀ was set to 5 wt %. The electrode plate CNT amount was 1 wt %, which satisfies the second condition. The CNT coverage θ was 13.4%, which does not satisfy the third condition. The durability characteristic in this case was 70.2%.

Conclusion of Experiment 1

FIG. 8 is a graph plotting the relationship of the total carbon amount TC (wt %) and the durability characteristic (%) shown in FIG. 7. Plotted point P1 is a point that corresponds to the total carbon amount TC (wt %) and the durability characteristic (%) of Reference Example 1. In the same manner, plotted point P2 corresponds to Comparative Example 1, plotted point P3 corresponds to Example 1, plotted point P4 corresponds to Example 2, and plotted point P5 corresponds to Example 3. Graph L1 was obtained based on plotted points P1 to P5 and other points that are not shown.

In the present embodiment, plotted point P1 of Reference Example 1 does not satisfy the first condition, and the durability characteristic (%) was as low as 70.2%. Plotted point P2 of Comparative Example 1 does not satisfy the first condition either, and the durability characteristic (%) was 84.5%, which is less than the value (90%) in the present embodiment. Plotted point P3 of Example 1 satisfies the first condition, and the durability characteristic (%) was 100%, which is almost the peak value. Plotted point P4 of Example 2 satisfies the first condition, and the durability characteristic (%) was 95.4%, which is close to the value of Example 1. Plotted point P5 of Example 3 also satisfies the first condition, and the durability characteristic (%) was 91.4%, which is substantially satisfactory as a product.

Graph L1 was obtained from the experimental results through multiple regression analysis. Graph L1 shows that the durability characteristic (%) is expected to be approximately 90% when the total carbon amount TC (wt %) is 0.05 wt % or greater and 0.21 wt % or less. This range was set as the first condition.

Experiment 2: CNT Coverage θ (%) and Output Characteristic (%)

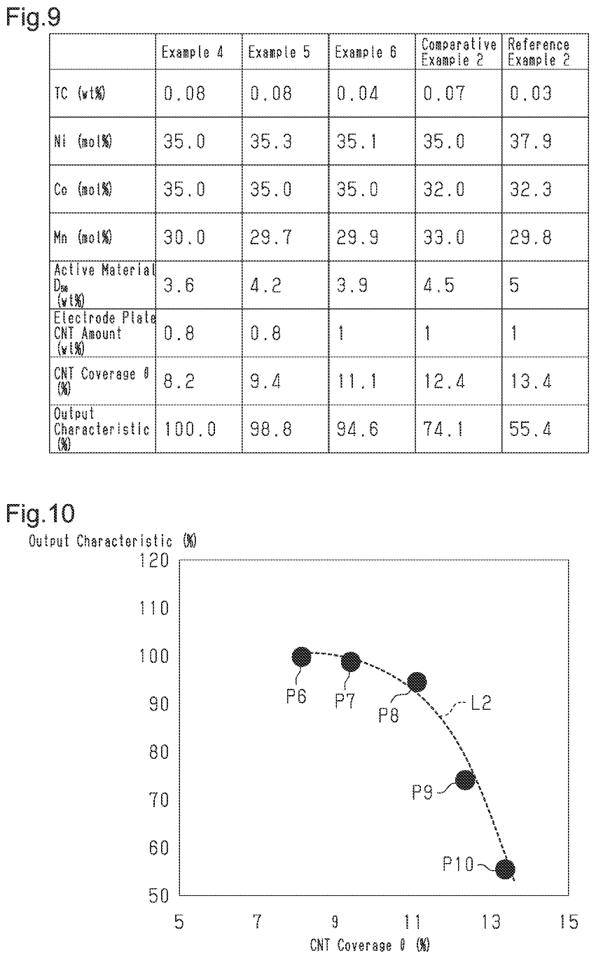

FIG. 9 is a table of experimental examples showing the relationship of the CNT coverage (%) and an output characteristic (%). In the third condition, the coverage θ (%) of the fibrous conductor 32b with respect to the positive electrode active material 32a is set to 11.0% or less. In Experiment 2, the output characteristic (%) was measured with respect to the coverage θ (%). The output characteristic depends on the battery capacity (Wh).

Example 4: The total carbon amount TC was 0.08 wt %, which satisfies the first condition. Ni was set to 35.0 mol %, Co was set to 35.0 mol %, Mn was set to 30.0 mol %, and the active material D₅₀ was set to 3.6 wt %. The electrode plate CNT amount was 0.8 wt %, which satisfies the second condition. The CNT coverage θ (%) was 8.2%, which satisfies the third condition. The output characteristic in this case was specified as 100%.

Example 5: The total carbon amount TC was 0.08 wt %, which satisfies the first condition. Ni was set to 35.3 mol %, Co was set to 35.0 mol %, Mn was set to 29.7 mol %, and the active material D₅₀ was set to 4.2 wt %. The electrode plate CNT amount was 0.8 wt %, which satisfies the second condition. The CNT coverage θ (%) was 9.4%, which satisfies the third condition. The output characteristic in this case was 98.8%.

Example 6: The total carbon amount TC was 0.04 wt %, which is slightly outside the first condition. Ni was set to 35.1 mol %, Co was set to 35.0 mol %, Mn was set to 29.9 mol %, and the active material D₅₀ was set to 3.9 wt %. The electrode plate CNT amount was 1 wt %, which satisfies the second condition. The CNT coverage θ (%) was 11.1%, which is slightly outside the third condition. The output characteristic in this case was 94.6%.

Comparative Example 2: The total carbon amount TC was 0.07 wt %, which satisfies the first condition. Ni was set to 35.0 mol %, Co was set to 32.0 mol %, Mn was set to 33.0 mol %, and the active material D₅₀ was set to 4.5 wt %. The electrode plate CNT amount was 1 wt %, which satisfies the second condition. The CNT coverage θ was 12.4%, which does not satisfy the third condition. The output characteristic in this case was 74.1%.

Reference Example 2: The total carbon amount TC was 0.03 wt %, which does not satisfy the first condition. Ni was set to 37.9 mol %, Co was set to 32.3 mol %, Mn was set to 29.8 mol %, and the active material D₅₀ was set to 5 wt %. The electrode plate CNT amount was 1 wt %, which satisfies the second condition. The CNT coverage θ (%) was 13.4%, which does not satisfy the third condition. The output characteristic in this case was 55.4%.

Conclusion of Experiment 2

FIG. 10 is a graph plotting the relationship of the CNT coverage θ (%) and the output characteristic (%) shown in FIG. 9. Plotted point P6 is a point that corresponds to the CNT coverage θ (%) and the output characteristic (%) of Example 4. In the same manner, plotted point P7 corresponds to Example 5, plotted point P8 corresponds to Example 6, plotted point P9 corresponds to Comparative Example 2, and plotted point P10 corresponds to Reference Example 2. Graph L2 was obtained through multiple regression analysis based on plotted points P6 to P10 and other points that are not shown.

As graph L2 indicates, Example 4, in which the CNT coverage θ (%) was 8.2%, serves as the reference of the output characteristic (%). In this case, when the CNT coverage rate θ (%) is 11.0%, the output characteristic (%) is approximately 95%. In the present embodiment, this range is acceptable as the set reference for a product. Therefore, as the third condition of the present embodiment, the coverage θ (%) of the fibrous conductor 32b with respect to the positive electrode active material 32a is set to 11.0% or less.

A preferred coverage θ (%) of the fibrous conductor 32b to the positive electrode active material 32a can be theoretically obtained with, for example, equation 1 shown below. The “a (%)” represents the composition ratio of the fibrous conductor 32b to the positive electrode active material 32a. Preferably, “a (%)” is between 0.5 wt % and 2.0 wt %, inclusive. The “b (%)” represents the coverage θ (%) of the fibrous conductor 32b. The “c (μm)” represents the average diameter D₅₀ (μm) of the positive electrode active material 32a, and is preferably between 2.5 μm and 5.5 μm, inclusive.

b=−8.583+(a×11.63)+(c×2.07)≤11.0 (equation 1)

Advantages of Present Embodiment

(1) The positive electrode plate 3 for the lithium-ion rechargeable battery 1 in accordance with the present embodiment improves the durability characteristic of the lithium-ion rechargeable battery 1.

(2) The fibrous conductor 32b is combined with the positive electrode active material 32a in which the amount of lithium carbonate 32c with respect to the positive electrode active material 32a is between 0.31 wt % and 1.29 wt %, inclusive. Thus, lithium carbonate 32c restricts generation of NiO effectively. Further, even a small amount of the fibrous conductor 32b can form an effective conductive network.

(3) The composition ratio of the fibrous conductor 32b to the positive electrode active material 32a is 0.5 wt % or greater. This ensures a sufficient amount of the fibrous conductor 32b for forming the conductive network.

(4) The fibrous conductor 32b includes carbon nanotubes (CNT) or carbon nanofibers (CNF). Further, the length of the fibrous conductor 32b is set to 100 nm to 1000 nm. In this manner, the fibrous conductor 32b forms an effective conductive network.

(5) The composition ratio of the fibrous conductor 32b to the positive electrode active material 32a is 2.0 wt % or less, and the coverage θ of the fibrous conductor 32b with respect to the positive electrode active material 32a is 11.0% or less. In this manner, the fibrous conductor 32b does not interfere with the main reaction of the positive electrode active material 32a.

(6) The positive electrode active material 32a is represented by the chemical formula of LiNiₓCo_{y}M_{z}O₂. The “M” represents one or more types of metal selected from the group consisting of Fe, Cu, Ti, Mg, Al, W, B, Mo, Nb, Zn, Sn, Zr, Ga, and V. In this case, the composition ratio of Li/M is set between 1.15 and 1.21, inclusive. This ensures a sufficient amount of lithium and stabilizes the battery performance.

(7) In the chemical formula of LiNiₓCo_{y}M_{z}O₂, the positive electrode active material 32a satisfies x=1-y-z, 0<x≤0.5, 0.2≤y≤0.5, y+z≥0.5, and y/x≥0.98. Preferably, x≤0.37 is satisfied. This limits the amount of Ni and ensures a sufficient amount of Co. Accordingly, the amount of lithium ions is increased in the positive electrode, thereby avoiding deterioration caused by Ni, such as cation mixing, formation of the layered rock-salt structure, or the like.

(8) The lithium-ion rechargeable battery 1 of the present embodiment includes such a positive electrode plate 3 for a lithium-ion rechargeable battery 1 and thus the battery performance is high in durability characteristic and excellent in output characteristic.

### Modified Examples

The present embodiment is an example of the present disclosure. The present disclosure is not limited to the description of the embodiment and may be implemented as follows.

The lithium carbonate 32c included in the positive electrode active material 32a of the present embodiment derives from the raw materials of the positive electrode active material 32a. However, lithium carbonate 32c may be added to the positive electrode active material 32a.

The numerical values and the like included in the present embodiment are examples and can be optimized by one skilled in the art without departing from the scope of the claims.

The drawings of the fibrous conductor 32b and the positive electrode active material 32a schematically illustrate the structures to facilitate understanding of the specification, and do not depict actual size or shape of the particles.

The present embodiment describes a battery pack combining vehicle on-board battery cells as an example. However, there is no limit to the application or the like of the present disclosure.

Further, the battery is not limited in shape or size.

The electrode body 12 is a roll and the cross section has the form of a racetrack. However, the electrode body 12 may have the shape of a circular column. Alternatively, the electrode body 12 may be a stack of planar electrode plates.

It should be apparent to one skilled in the art that the present disclosure may be implemented by adding, deleting, or changing the structure without departing from the scope of the claims.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A positive electrode plate for a lithium-ion rechargeable battery, the positive electrode comprising:
a positive electrode mixture layer, wherein:
in the positive electrode mixture layer, a fibrous conductor is combined with a positive electrode active material in which an amount of lithium carbonate with respect to the positive electrode active material is between 0.31 wt % and 1.29 wt %, inclusive;
a composition ratio of the fibrous conductor to the positive electrode active material is between 0.5 wt % and 2.0 wt %, inclusive; and
a coverage of the fibrous conductor to the positive electrode active material is 11.0% or less.

2. The positive electrode plate according to claim 1, wherein:
the positive electrode active material is represented by a chemical formula of LiNiₓCo_{y}M_{z}O₂; and
when “M” represents one or more types of metals selected from a group consisting of Fe, Cu, Ti, Mg, Al, W, B, Mo, Nb, Zn, Sn, Zr, Ga, and V, a composition ratio of Li/M is between 1.15 and 1.21, inclusive.

3. The positive electrode plate according to claim 1, wherein:
when “M” represents one or more types of metals selected from a group consisting of Fe, Cu, Ti, Mg, Al, W, B, Mo, Nb, Zn, Sn, Zr, Ga, and V,
the positive electrode active material is represented by a chemical formula of LiNiₓCo_{y}M_{z}O₂;
x=1-y-z is satisfied;
0<x≤0.5 is satisfied;
0.2≤y≤0.5 is satisfied;
y+z≥0.5 is satisfied; and
y/x≥0.98 is satisfied.

4. The positive electrode plate according to claim 3, wherein the “x” satisfies x≤0.37.

5. The positive electrode plate according to claim 1, wherein the fibrous conductor is formed by carbon nanotubes or carbon nanofibers.

6. The positive electrode plate according to claim 5, wherein the fibrous conductor has a length of 100 nm to 1000 nm.

7. A lithium-ion rechargeable battery, comprising:
the positive electrode plate for a lithium-ion rechargeable battery according to claim 1.
